(19) United States
(12) Patent Application Publication
(10) Pub. No.: US 2021/0117094 A1
(43) Pub. Date: Apr. 22, 2021

(54) MIRRORING DATA ONTO DISPARATE TYPES OF NON-VOLATILE DATA STORAGE

(71) Applicant: EMC IP Holding Company LLC, Hopkinton, MA (US)

(72) Inventors: Vamsi K. Vankamamidi, Hopkinton, MA (US); Marc Cassano, Mendon, MA (US); Daniel E. Cummins, Hudson, NH (US)

(21) Appl. No.: 16/654,766

(22) Filed: Oct. 16, 2019

(51) Int. Cl. G06F 3/06

(52) U.S. Cl. CPC G06F 3/065; G06F 3/0685; G06F 3/0614

(57) ABSTRACT

A data storage system in which physical extents of non-volatile data storage are provisioned from non-volatile data storage devices of disparate types for purposes of data mirroring. Data indicated by at least one write operation is mirrored onto the physical extents of non-volatile data storage provisioned from the non-volatile data storage devices of disparate types. A change in performance requirements for the data may cause a new physical extent to be provisioned from another type of non-volatile data storage device, and then used to replace one of the originally provisioned physical extents, such that data indicated by subsequently received write operations is mirrored onto the newly provisioned physical extent and those of the originally provisioned physical extents that were not replaced by the newly provisioned physical extent.

### TECHNICAL FIELD

The disclosed technology relates generally to securely storing data in a data storage system, and more specifically to technology for mirroring data onto disparate types of non-volatile data storage.

### BACKGROUND

Data storage systems are arrangements of hardware and software that include and/or access non-volatile data storage (e.g. electronic flash drives, magnetic disk drives, and/or optical drives, cloud storage, etc.) that is used to provide non-volatile storage for processing I/O (Input/Output) requests (i.e. writes and/or reads) that are received from one or more hosts (e.g. host computers and/or applications executing thereon). The host I/O requests that are processed by a data storage system may include block I/O requests as well as file I/O requests. The host I/O requests indicate host data that is stored in storage objects (e.g. logical volumes) of non-volatile data storage that are contained in and maintained by the data storage system. The data storage system may also perform various data storage related services that organize and secure the host data on the non-volatile data storage of the data storage system.

### SUMMARY

While processing received host I/O requests and/or providing data storage related services, a data storage system may mirror data onto a set of two or more non-volatile data storage devices in order provide high data availability. In previous systems, mirroring has been performed only between non-volatile data storage devices of the same type, e.g. between non-volatile data storage devices having the same performance characteristics. For example, some previous systems have mirrored data between two or more magnetic disk drives of the same type, between two or more solid state drives of the same type, and so on.

Technologies that mirror data only between non-volatile data storage devices of the same type have exhibited shortcomings in the utilization of data storage system resources. For example, when data is mirrored between two high speed non-volatile data storage devices, and the data is then primarily or only being accessed by read operations, the high performance (and concomitant high cost) of both high speed devices is not needed to provide high performance with regard to data access time, since only one of the devices is needed to read the mirrored data. As a result, the high speed of the second one of the relatively high cost, high performance non-volatile data storage devices that is provided for purposes of reliability is effectively wasted, resulting in unnecessarily high data storage costs.

Technologies that only mirror data between non-volatile data storage devices of the same type may also exhibit shortcomings when the devices are changed to match changing performance requirements of the data being mirrored. For example, the performance requirements of a set of data may change when the data storage system detects that the access pattern for the data has changed over time. In another example, the performance requirements of a set of data may change when a system manager manually changes specific settings that expressly indicate the performance requirements of the data. In either case, in response to the change in performance requirements, the set of devices onto which the data is mirrored may be automatically changed so that the non-volatile data storage devices onto which the data is mirrored have performance characteristics that match the new performance requirements of the data being mirrored.

When performance requirements for data increase, changing the non-volatile data storage devices onto which the data is mirrored to a set of relatively higher performance non-volatile data storage devices is sometimes referred to as “up-tiering” the data. When performance requirements for the data decrease, changing the non-volatile data storage devices onto which the data is mirrored to relatively lower performance non-volatile data storage devices is sometimes referred to as “down-tiering” the data. In either case, previous systems that only mirror data between non-volatile data storage devices of the same type have responded to changes in performance requirements by provisioning a completely new set of non-volatile data storage devices that all have performance characteristics that meet the new performance requirements, and then copying the previously mirrored data to all of the newly provisioned non-volatile data storage devices. Such an approach is resource intensive with regard to having to copy the previously stored data onto all of the newly provisioned data storage devices that match the new performance requirements. The time required to perform the copying onto all the newly provisioned data storage devices that match the new performance requirements also creates a significant time delay with regard to releasing the non-volatile data storage that was previously used to support the data mirroring, thus delaying the re-provisioning of the released non-volatile data storage to support the mirroring of another set of data.

To provide improvements with regard to the above described and other technical shortcomings of previous systems, new technology is disclosed herein in which physical extents of non-volatile data storage are provisioned for data mirroring from non-volatile data storage devices of disparate types. When at least one write operation is then received, the data indicated by the write operation is mirrored onto the physical extents of non-volatile data storage provisioned from the non-volatile data storage devices of disparate types.

For example, provisioning the physical extents of non-volatile data storage from non-volatile data storage devices of disparate types for data mirroring may include provisioning a first physical extent from a non-volatile data storage device of a first type having a first set of performance characteristics, and provisioning a second physical extent from a non-volatile data storage device of a second type having a second set of performance characteristics that is different from the first set of performance characteristics. Mirroring the data indicated by the write operation onto the physical extents of non-volatile data storage provisioned from the non-volatile data storage devices of disparate types may then be accomplished by mirroring the data indicated by the write operation onto the first physical extent and the second physical extent.

In another example, the first set of performance characteristics may include the speed (e.g. access time) of the non-volatile data storage device of the first type, and the second set of performance characteristics may include the speed of the non-volatile data storage device of the second type. The speed of the non-volatile data storage device of the second type may be different from the speed of the non-volatile data storage device of the first type (e.g. may be higher or lower).

In another example, the first set of performance characteristics may include reliability (e.g. annual failure rate) of the non-volatile data storage device of the first type, and the second set of performance characteristics may include reliability of the non-volatile data storage device of the second type. The reliability of the non-volatile data storage device of the second type may be different from the reliability of the non-volatile data storage device of the first type (e.g. higher or lower).

In another example, the first set of performance characteristics may include an expected lifetime (e.g. terabytes written before failure) of the non-volatile data storage device of the first type, and the second set of performance characteristics may include an expected lifetime of the non-volatile data storage device of the second type. The expected lifetime of the non-volatile data storage device of the second type may be different from the expected lifetime of the non-volatile data storage device of the first type (e.g. longer or shorter).

In another example, the disclosed technology may detect a change in performance requirements for the data being mirrored. In response to detecting the change in performance requirements for the data being mirrored, the disclosed technology may provision a third physical extent from a non-volatile data storage device of a third type having a third set of performance characteristics that is different from both the first set of performance characteristics and the second set of performance characteristics. Mirroring of data indicated by at least one subsequently received write operation may then include mirroring the data onto the first physical extent and the third physical extent.

In another example, further in response to detecting the change in the performance requirements for the data, contents of the second physical extent may be copied to the third physical extent. Mirroring of the data indicated by at least one subsequently received write operation onto the first physical extent and the third physical extent may be performed in response to completion of the copying of the contents of the second physical extent to the third physical extent.

In another example, the second physical extent may be released for re-provisioning in response to completing the copying of the contents of the second physical extent onto the third physical extent. Subsequently received read operations may then be processed by reading the mirrored data from the first physical extent.

In another example, multiple write operations may be performed, and completion of each individual write operation may be indicated after the data indicated by that write operation is successfully mirrored onto each of the physical extents of non-volatile data storage provisioned from the non-volatile data storage devices of disparate types.

The disclosed technology may provide significant improvements over previous technologies. For example, the disclosed technology may use non-volatile data storage resources more efficiently than previous systems that only mirrored data between non-volatile data storage devices of the same type. For example, in the case where data is primarily or only being accessed by read operations, only one high performance/higher cost drive extent is needed to provide high speed processing of the read requests, and the disclosed technology enables other drive extent(s) onto which the data is mirrored to be located on lower performance/lower cost drives, leaving more high performance non-volatile data storage resources available to mirror other data, and/or lowering overall non-volatile data storage costs.

In another example improvement, the disclosed technology improves over previous systems when data performance requirements change, since only one of the physical extents needs to be changed to perform either up-tiering or down-tiering of the data being mirrored. As a result, when the mirrored data is either up-tiered or down-tiered, fewer data storage system resources are required to copy the previously mirrored data onto the single newly provisioned physical extent. In addition, the time required to perform the copy of the data to the single newly provisioned physical extent is shorter in comparison to the copy time required by previous systems, in which a complete set of new physical extents located on non-volatile data storage devices with the new performance characteristics had to be populated with previously mirrored data. In comparison with previously systems, the disclosed technology accordingly enables the physical extent being replaced to be made available relatively quickly for re-provisioning to support the mirroring of another set of data.

### BRIEF DESCRIPTION OF THE DRAWINGS

The foregoing and other objects, features and advantages will be apparent from the following description of particular embodiments of the disclosed technology, as illustrated in the accompanying drawings in which like reference characters refer to the same parts throughout the different views. The drawings are not necessarily to scale, emphasis instead being placed on illustrating the principles of various embodiments of the disclosed technology.

FIG. 1 is a block diagram showing an example of components in some embodiments provisioning physical extents of non-volatile data storage for data mirroring from non-volatile data storage devices of disparate types, receiving one or more write operations, and mirroring the data indicated by the write operations onto the physical extents of non-volatile data storage provisioned from non-volatile data storage devices of disparate types;

FIG. 2 is a block diagram showing how in some embodiments of the disclosed technology, data indicated by write operations directed to a logical extent of logical addresses within a logical address space may be mapped to and mirrored onto each physical extent in a mirror set of physical extents of non-volatile data storage provisioned from non-volatile data storage devices of disparate types;

FIG. 3 is a block diagram showing the components of FIG. 1 detecting a change in the performance requirements for the data being mirrored, and provisioning a new physical extent from a non-volatile data storage device of a type having performance characteristics that match the new performance characteristics of the data being mirrored in order to replace one of the previously provisioned physical extents, and copying previously mirrored data onto the newly provisioned physical extent;

FIG. 4 is a block diagram showing the components of FIGS. 1 and 3, after one of the initially provisioned physical extents has been released for re-provisioning to support mirroring of other host data;

FIG. 5 is a block diagram showing an example of how data indicated by write operations directed to the logical extent of logical addresses shown in FIG. 2 may be mapped to and mirrored onto each physical extent in an updated mirror set of physical extents of non-volatile data storage provisioned from non-volatile data storage devices of disparate types;

FIG. 6 is a block diagram showing an example of servicing read operations using a relatively higher performance physical extent in the physical extents in the mirror set;

FIG. 7 is a block diagram showing how read operations directed to the logical extent within the logical address space may be processed using the relatively higher performance physical extent in the physical extents in the mirror set;

FIG. 8 is a first flow chart illustrating steps that may be performed during operation of some embodiments; and

FIG. 9 is a second flow chart illustrating steps that may be performed during operation of some embodiments.

### DETAILED DESCRIPTION

Embodiments of the invention will now be described. The embodiments described herein are only examples of how features and principles of the invention may be embodied. The invention itself is accordingly broader than the specific examples described below.

The technology disclosed herein provides improvements over previous systems by provisioning physical extents of non-volatile data storage for data mirroring from non-volatile data storage devices of disparate types. When write operations are received, the data indicated by the write operations is mirrored onto physical extents of non-volatile data storage provisioned from non-volatile data storage devices of disparate types.

In some embodiments, provisioning the physical extents of non-volatile data storage from non-volatile data storage devices of disparate types for data mirroring may include provisioning a first physical extent from a non-volatile data storage device of a first type having a first set of performance characteristics and provisioning a second physical extent from a non-volatile data storage device of a second type having a second set of performance characteristics that is different from the first set of performance characteristics. In such embodiments, mirroring the data indicated by the write operation(s) onto the physical extents of non-volatile data storage provisioned from the non-volatile data storage devices of disparate types may then include mirroring the data indicated by the write operation(s) onto the first physical extent and the second physical extent.

In some embodiments, the first set of performance characteristics may include the speed (e.g. access time) of the non-volatile data storage device of the first type, and the second set of performance characteristics may include the speed of the non-volatile data storage device of the second type. In such embodiments, the speed of the non-volatile data storage device of the second type may be different from the speed of the non-volatile data storage device of the first type (e.g. may be higher or lower).

In some embodiments, the first set of performance characteristics may include reliability (e.g. annual failure rate) of the non-volatile data storage device of the first type, and the second set of performance characteristics may include reliability of the non-volatile data storage device of the second type. In such embodiments, the reliability of the non-volatile data storage device of the second type may be different from the reliability of the non-volatile data storage device of the first type (e.g. higher or lower).

In some embodiments, the first set of performance characteristics may include an expected lifetime (e.g. terabytes written before failure) of the non-volatile data storage device of the first type, and the second set of performance characteristics may include an expected lifetime of the non-volatile data storage device of the second type. In such embodiments, the expected lifetime of the non-volatile data storage device of the second type may be different from the expected lifetime of the non-volatile data storage device of the first type (e.g. longer or shorter).

In some embodiments, a change may be detected in performance requirements for the data being mirrored. In such embodiments, in response to detecting the change in performance requirements for the data, a third physical extent may be provisioned from a non-volatile data storage device of a third type having a third set of performance characteristics that is different from both the first set of performance characteristics and the second set of performance characteristics. In such embodiments, mirroring of the data indicated by at least one subsequently received write operation may then be performed by mirroring the data onto the first physical extent and the third physical extent.

In some embodiments, further in response to detection of a change in the performance requirements for the data, the contents of the second physical extent may be copied to the third physical extent. In such embodiments, mirroring of the data indicated by at least one subsequently received write operation onto the first physical extent and the third physical extent may be performed in response to completion of the copying of the contents of the second physical extent to the third physical extent.

In some embodiments, the second physical extent may be released for re-provisioning in response to completion of the copying of the contents of the second physical extent onto the third physical extent. Subsequently received read operations may then be processed by reading the mirrored data from the first physical extent.

In some embodiments, completion of each individual write operation may be indicated only after the data indicated by that write operation is successfully mirrored onto each of the physical extents of non-volatile data storage provisioned from the non-volatile data storage devices of disparate types.

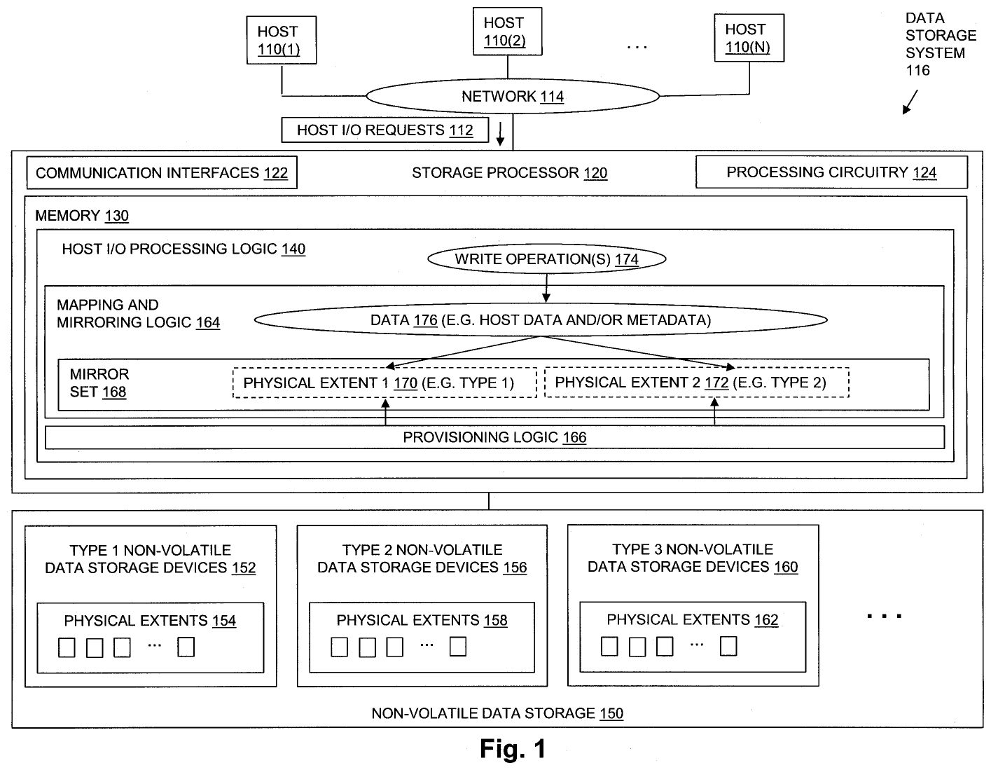

FIG. 1 shows an example of an operational environment in which embodiments of the disclosed technology may operate, and an illustrative embodiment of components of the disclosed technology. As shown in FIG. 1, one or more host computers (“Hosts”), shown as host computers 110(1) through 110(N), and/or host applications executing in whole or in part on host computers 110(1) through 110(N), access non-volatile data storage provided by Data Storage System 116 over a Network 114. Hosts 110 may consist of or include one or more physical computers, and/or one or more virtual machines executing in a virtual execution environment.

Data Storage System 116 includes at least one Storage Processor 120, and Non-Volatile Data Storage 150 is communicably connected to Storage Processor 120. Non-Volatile Data Storage 150 includes some number of non-volatile data storage devices that are each communicably connected either directly or indirectly to Storage Processor 120. For example, one or more of the non-volatile data storage devices in Non-Volatile Data Storage 150 may be connected to Storage Processor 120 through a high speed bus, such as PCI Express (Peripheral Component Interconnect Express) or the like, and/or using one or more cables or communication media, such as SAS (Serial-Attached SCSI (Small Computer System Interface)) cables, and/or through one or more Ethernet cables, and/or other specific types of communication media and/or one or more communication or computer networks.

The non-volatile data storage devices in Non-Volatile Data Storage 150 include non-volatile data storage devices of disparate types. For purposes of illustration, the non-volatile data storage devices in Non-Volatile Data Storage 150 are shown including Type 1 Non-Volatile Data Storage Devices 152, Type 2 Non-Volatile Data Storage Devices 156, Type 3 Non-Volatile Data Storage Devices 160, and so on. The disclosed technology may be embodied or configured to operate with any specific number of disparate types of non-volatile data storage devices.

The non-volatile data storage devices of each individual type have the same set of performance characteristics. For example, each non-volatile data storage device in Type 1 Non-Volatile Data Storage Devices 152 has the same set of performance characteristics as each other non-volatile data storage data storage device in Type 1 Non-Volatile Data Storage Devices 152, each non-volatile data storage device in Type 2 Non-Volatile Data Storage Devices 156 has the same set of performance characteristics as each other non-volatile data storage data storage device in Type 2 Non-Volatile Data Storage Devices 156, each non-volatile data storage device in Type 3 Non-Volatile Data Storage Devices 160 has the same set of performance characteristics as each other non-volatile data storage data storage device in Type 3 Non-Volatile Data Storage Devices 160, and so on.

The non-volatile data storage devices of each individual type have different performance characteristics with respect to the performance characteristics of the other types of non-volatile data storage devices. For example, Type 1 Non-Volatile Data Storage Devices 152 have a different set of performance characteristics with respect to both Type 2 Non-Volatile Data Storage Devices 156 and Type 3 Non-Volatile Data Storage Devices 160, Type 2 Non-Volatile Data Storage Devices 156 have a different set of performance characteristics with respect to both Type 1 Non-Volatile Data Storage Devices 152 and Type 3 Non-Volatile Data Storage Devices 160, and Type 3 Non-Volatile Data Storage Devices 160 have a different set of performance characteristics with respect to both Type 2 Non-Volatile Data Storage Devices 156 and Type 1 Non-Volatile Data Storage Devices 152.

The set of performance characteristics for each type of non-volatile data storage device may include one or more performance characteristics indicating the speed (e.g. data access time), reliability (e.g. annual failure rate), and/or expected lifetime (e.g. terabytes written before failure) of the non-volatile data storage devices of that type.

In some cases, for example, Type 1 Non-Volatile Data Storage Devices 152 may have a set of performance characteristics indicating a speed that is higher (e.g. a lower data access time) than the speed of both Type 2 Non-Volatile Data Storage Devices 156 and Type 3 Non-Volatile Data Storage Devices 160, Type 2 Non-Volatile Data Storage Devices 156 may have a set of performance characteristics indicating a speed that is lower (e.g. a higher data access time) than the speed of Type 1 Non-Volatile Data Storage Devices 152 but is higher (e.g. a lower data access time) than Type 3 Non-Volatile Data Storage Devices 160, and Type 3 Non-Volatile Data Storage Devices 160 may have a set of performance characteristics indicating a speed that is lower (e.g. a higher data access time) than the speed of both Type 1 Non-Volatile Data Storage Devices 152 and Type 2 Non-Volatile Data Storage Devices 156. In such embodiments, for example, Type 1 Non-Volatile Data Storage Devices 152 may be made up of one or more solid state drives, Type 2 Non-Volatile Data Storage Devices 156 may be made up of one or more magnetic disk drives, and Type 3 Non-Volatile Data Storage Devices 160 may include or consist of one or more external cloud storage servers accessed by Storage Processor 120 through a cloud storage service or the like.

In some cases, for example, Type 1 Non-Volatile Data Storage Devices 152 may have a set of performance characteristics indicating a reliability that is higher (e.g. a lower annual failure rate) than the reliability of both Type 2 Non-Volatile Data Storage Devices 156 and Type 3 Non-Volatile Data Storage Devices 160, Type 2 Non-Volatile Data Storage Devices 156 may have a set of performance characteristics indicating a reliability that is lower (e.g. a higher annual failure rate) than the reliability of Type 1 Non-Volatile Data Storage Devices 152 but is higher (e.g. a lower annual failure rate) than the reliability of Type 3 Non-Volatile Data Storage Devices 160, and Type 3 Non-Volatile Data Storage Devices 160 may have a set of performance characteristics indicating a reliability that is lower (e.g. a higher annual failure rate) than the reliability of both Type 1 Non-Volatile Data Storage Devices 152 and Type 2 Non-Volatile Data Storage Devices 156.

In some cases, for example, Type 1 Non-Volatile Data Storage Devices 152 may have a set of performance characteristics indicating an expected lifetime that is higher (e.g. a higher terabytes written before failure) than an expected lifetime of both Type 2 Non-Volatile Data Storage Devices 156 and Type 3 Non-Volatile Data Storage Devices 160, Type 2 Non-Volatile Data Storage Devices 156 may have a set of performance characteristics indicating an expected lifetime that is lower (e.g. a lower terabytes written before failure) than the expected lifetime of Type 1 Non-Volatile Data Storage Devices 152 but is higher (e.g. a higher terabytes written before failure) than the expected lifetime of Type 3 Non-Volatile Data Storage Devices 160, and Type 3 Non-Volatile Data Storage Devices 160 may have a set of performance characteristics indicating an expected lifetime that is lower (e.g. a lower terabytes written before failure) than the expected lifetimes of both Type 1 Non-Volatile Data Storage Devices 152 and Type 2 Non-Volatile Data Storage Devices 156.

While the set of performance characteristics for each type of non-volatile data storage device may include performance characteristics such as those described above indicating the speed, reliability, and/or expected lifetime of the non-volatile data storage devices of that type, those skilled in the art will recognize that the disclosed technology is not limited to operation with those specific performance characteristics, and that other specific differing performance characteristics may be indicated in the alternative or in addition to speed, reliability, and/or expected lifetime.

Data Storage System 116 may include one or more storage processors like Storage Processor 120. In some embodiments, multiple storage processors may be provided as circuit board assemblies, or “blades,” which plug into a chassis that encloses and cools the storage processor. Those skilled in the art will recognize, however, that no particular configuration of storage processors is required, as any number of storage processors, including a single storage processor, may be provided, and that Storage Processor 120 may be any type of physical or virtual computing device that is capable of processing host I/O requests.

Network 114 may include or consist of any type of network or combination of networks, such as, for example, a storage area network (SAN), a local area network (LAN), a wide area network (WAN), the Internet, and/or some other type of communication or computer network or combination of networks.

Hosts 110(1-N) and/or host applications executing in whole or in part on Hosts 110(1-N) may logically connect to and communicate with the Storage Processor 120 using various technologies. For example, Host I/O Requests 112 conveyed from Hosts 110(1-N) to Storage Processor 120 may include block I/O requests (read requests and/or write requests) that are communicated from Hosts 110(1-N) to Storage Processor 120 using block storage interfaces and protocols such as, for example, the Small Computer System Interface (SCSI), Fibre Channel (FC), Serial Attached SCSI (SAS), Internet Small Computer System Interface (iSCSI), and/or other block storage interfaces and/or protocols. Host I/O Requests 112 conveyed from Hosts 110(1-N) to Storage Processor 120 may further include file I/O requests (read requests and/or write requests) communicated from Hosts 110(1-N) to the Storage Processor 120 using file storage interfaces and protocols such as, for example, the Network File System (NFS) distributed file system protocol, the Server Message Block (SMB)/Common Internet File System (CIFS) application-layer network protocol, Apple Filing Protocol (AFP), and/or other file storage interfaces and/or protocols. Storage Processor 120 may accordingly be configured to receive host I/O requests through block-based and/or file-based storage protocols, and to respond to host I/O requests of either type by reading host data from and/or writing host data to Non-Volatile Data Storage 150, as further described below.

Storage Processor 120 may include one or more Communication Interfaces 122, Processing Circuitry 124, and Memory 130 coupled to Processing Circuitry 124. The Communication Interfaces 122 of Storage Processor 120 may include, for example, SCSI target adapters and/or network interface adapters that convert electronic and/or optical signals received over Network 114 into electronic form for use by Storage Processor 120.

Processing Circuitry 124 may, for example, be embodied as at least one processor core that is capable of reading and executing threads of program instructions as they are scheduled for execution. Processing Circuitry 124 may be integrated into a single central processing unit chip or chip package. Processing Circuitry 124 may be a subset of the total number of processor cores contained in Storage Processor 120, or may be the only processor core contained in Storage Processor 120.

Memory 130 may, for example, include or consist of relatively high speed, volatile memory, e.g. Dynamic Random Access Memory (DRAM). Processing Circuitry 124 and Memory 130 together may form specialized control circuitry, which is constructed and arranged to carry out specific methods and functions as described herein. As shown in FIG. 1, Memory 130 stores specialized software components and data structures that may be provided at least in part in the form of executable program instructions. When the executable instructions of the software components shown in FIG. 1 are executed by Processing Circuitry 124, Processing Circuitry 124 performs the methods and functionality of the software described herein. Although certain specific software constructs are shown in FIG. 1 and described herein, those skilled in the art will recognize that Memory 130 may further include various other types of software constructs, which are not shown.

In the example of FIG. 1, the software components in Memory 130 include Host I/O Processing Logic 140, which provides program logic for processing and/or supporting the processing of the Host I/O Requests 112 received by Storage Processor 120, and program logic for providing one or more data storage related services. Host I/O Requests 112 may be processed by Host I/O Processing Logic 140, and may include host I/O requests (e.g. host I/O read requests and host I/O write requests) that are directed to various types of block data objects that are hosted by Data Storage System 116 using non-volatile data storage space that is allocated from the non-volatile data storage devices in one or more of the storage enclosures. Such block data objects may, for example, include logical volumes, logical units sometimes referred to as LUNs), and/or block-based virtual volumes (VVols). Host I/O Requests 112 processed by Host I/O Processing Logic 140 may also or alternatively include host I/O requests (e.g. host I/O read requests, host I/O write requests) directed to file data objects, such as files or file systems, that are also hosted by Data Storage System 116 using non-volatile data storage space that is also allocated from the non-volatile data storage devices in one or more of the storage enclosures.

During operation of the components shown in FIG. 1, Provisioning Logic 166 divides the physical non-volatile data storage space located on each one of the non-volatile data storage devices in Non-Volatile Data Storage 150 into multiple equal-sized physical extents (PEs), where each physical extent consists of a contiguous area of physical non-volatile data storage space. The disclosed technology may be embodied using any specific size of physical extents.

In the example of FIG. 1, the physical extents located on the Type 1 Non-Volatile Data Storage Devices 152 are shown by Physical Extents 154, the physical extents located on the Type 2 Non-Volatile Data Storage Devices 156 are shown by Physical Extents 158, and the physical extents located on the Type 3 Non-Volatile Data Storage Devices 160 are shown by Physical Extents 162.

Provisioning Logic 166 provisions physical extents located on non-volatile data storage devices of disparate types in Non-Volatile Data Storage 150 to support data mirroring across the provisioned physical extents. For example, Provisioning Logic 166 may initially provision a first physical extent, shown for purposes of illustration by Physical Extent 1 170, and a second physical extent Physical Extent 2 172, from non-volatile data storage devices of disparate types in Non-Volatile Data Storage 150, in order to mirror Data 176 across physical extents that are located on and provisioned from different types of non-volatile data storage devices. For example, Physical Extent 1 170 and Physical Extent 2 172 may be considered an Mirror set 168 that is initially provisioned for mirroring Data 176. While in FIG. 1 Mirror Set 168 includes two physical extents, the disclosed technology is not limited to using mirror sets that specifically include exactly two physical extents, and those skilled in the art will recognize that various other numbers of physical extents of disparate types may instead be included in mirror sets such as Mirror Set 168.

For example, Provisioning Logic 166 may i) provision Physical Extent 1 170 from a non-volatile storage device that is one of the Type 1 Non-Volatile Data Storage Devices 152, and ii) provision Physical Extent 2 172 from one of the non-volatile data storage devices that is one of the Type 2 Non-Volatile Data Storage Devices 156. In such an example, as illustrated in FIG. 1, Physical Extent 1 170 may be one of Physical Extents 154, and Physical Extent 2 172 may be one of Physical Extents 158.

After Physical Extent 1 170 and Physical Extent 2 172 have been provisioned for data mirroring, and Mirror Set 168 has as a result been initially established containing Physical Extent 1 170 and Physical Extent 2 172, one or more write operations, shown by Write Operations 174, are processed by Mapping and Mirroring Logic 164. Write Operations 174 indicate some amount of data, shown by Data 176, that is to be persistently stored into Non-Volatile Data Storage 150. Data 176 may, for example, include or consist of host data indicated by one or more of the host I/O write requests in Host I/O Requests 112. Data 176 may alternatively, or in addition, include or consist of metadata generated within Storage Processor 120 during the processing of Host I/O Requests 112.

In response to receipt of Write Operations 174, Mapping and Mirroring Logic 164 mirrors Data 176 onto all the physical extents contained in Mirror Set 168, e.g. onto Physical Extent 170 and Physical Extent 172. Mapping and Mirroring Logic 164 may mirror Data 176 onto Physical Extent 170 and Physical Extent 172 at least in part by storing identical copies of Data 176 onto both Physical Extent 170 and Physical Extent 172. In this way, for example, Mapping and Mirroring Logic 164 may mirror Data 176 onto physical extents that are located on and provisioned from non-volatile data storage devices of disparate types.

In order to mirror Data 176 onto Physical Extent 1 170 and Physical Extent 2 172, in response to receipt of Write Operations 174, Mapping and Mirroring Logic 164 may operate to identify Mirror Set 168 as the set of physical extents that have previously been provisioned to specifically support the mirroring of Data 176. For example, individual corresponding mirror sets of physical extents provisioned from non-volatile data storage devices of disparate types may be associated with corresponding individual logical extents within a logical address space that is generated by Mapping and Mirroring Logic 164 and exposed to various processes or threads within Host I/O Processing Logic 140 that persistently store data. Mapping and Mirroring Logic 164 may maintain one or more data structures that map each one of the logical extents in the logical address space to a corresponding mirror set of physical extents provisioned for mirroring the data written to that logical extent. While some or all of the mirror sets of physical extents provisioned to support mirroring may include physical extents provisioned from non-volatile data storage devices of disparate types (e.g. Mirror Set 168), other ones of the mirror sets may include physical extents provisioned from non-volatile data storage devices of a single type.

As mentioned above, each individual type of non-volatile data storage device in Non-Volatile Data Storage 150 may have a different set of performance characteristics. Accordingly, for example, Type 1 Non-Volatile Data Storage Devices 152 may have a first set of performance characteristics, and Type 2 Non-Volatile Data Storage Devices 156 may have a second set of performance characteristics that differs from the performance characteristics of Type 1 Non-Volatile Data Storage Devices 152. For example, Physical Extent 2 172 may be provisioned from a non-volatile data storage device having a set of performance characteristics that is different from the set of performance characteristics of the non-volatile data storage device from which Physical Extent 1 170 is provisioned. Accordingly, Mapping and Mirroring Logic 164 may mirror Data 176 onto Physical Extent 1 170 and Physical Extent 2 172 at least in part by storing Data 176 onto both i) a first physical extent provisioned from a non-volatile data storage device having a first set of performance characteristics and ii) a second physical extent provisioned from a non-volatile data storage device having a second set of performance characteristics that is different from the first set of performance characteristics.

As mentioned above, the set of performance characteristics for Type 1 Non-Volatile Data Storage Devices 152 may, for example, indicate the speed (e.g. data access time) of each one of the Type 1 Non-Volatile Data Storage Devices 152, and the set of performance characteristics for Type 2 Non-Volatile Data Storage Devices 156 may indicate the speed (e.g. data access time) of each one of the Type 1 Non-Volatile Data Storage Devices 152. For example, the set of performance characteristics for Type 1 Non-Volatile Data Storage Devices 152 may indicate that Type 1 Non-Volatile Data Storage Devices 152 each have a higher speed (e.g. lower access time) than the speed indicated in the performance characteristics for Type 2 Non-Volatile Data Storage Devices 156. Alternatively, the set of performance characteristics for Type 1 Non-Volatile Data Storage Devices 152 may indicate that Type 1 Non-Volatile Data Storage Devices 152 each have a lower speed (e.g. higher access time) than the speed indicated in the performance characteristics for Type 2 Non-Volatile Data Storage Devices 156. In either case, the performance characteristics of the non-volatile data storage device from which Physical Extent 1 170 is provisioned is different from the performance characteristics of the non-volatile storage device from which Physical Extent 2 172 is provisioned. Specifically, the speed of the non-volatile data storage device from which Physical Extent 1 170 is provisioned may be higher or lower than the speed of the non-volatile data storage device from which Physical Extent 2 172 is provisioned.

As also mentioned above, the set of performance characteristics for Type 1 Non-Volatile Data Storage Devices 152 may, for example, indicate the reliability (e.g. annual failure rate) of each one of the Type 1 Non-Volatile Data Storage Devices 152, and the set of performance characteristics for Type 2 Non-Volatile Data Storage Devices 156 may indicate the reliability (e.g. annual failure rate) of each one of the Type 1 Non-Volatile Data Storage Devices 152. For example, the set of performance characteristics for Type 1 Non-Volatile Data Storage Devices 152 may indicate that Type 1 Non-Volatile Data Storage Devices 152 each have a higher reliability (e.g. lower annual failure rate) than the reliability indicated in the performance characteristics for Type 2 Non-Volatile Data Storage Devices 156. Alternatively, the set of performance characteristics for Type 1 Non-Volatile Data Storage Devices 152 may indicate that Type 1 Non-Volatile Data Storage Devices 152 each have a lower reliability (e.g. higher annual failure rate) than the reliability indicated in the performance characteristics for Type 2 Non-Volatile Data Storage Devices 156. In either case, the performance characteristics of the non-volatile data storage device from which Physical Extent 1 170 is provisioned is different from the performance characteristics of the non-volatile storage device from which Physical Extent 2 172 is provisioned. Specifically, the speed of the non-volatile data storage device from which Physical Extent 1 170 is provisioned may be higher or lower than the speed of the non-volatile data storage device from which Physical Extent 2 172 is provisioned.

As further mentioned above, the set of performance characteristics for Type 1 Non-Volatile Data Storage Devices 152 may, for example, indicate the estimated lifetime (e.g. terabytes written before failure) of each one of the Type 1 Non-Volatile Data Storage Devices 152, and the set of performance characteristics for Type 2 Non-Volatile Data Storage Devices 156 may indicate the estimated lifetime (e.g. terabytes written before failure) of each one of the Type 1 Non-Volatile Data Storage Devices 152. For example, the set of performance characteristics for Type 1 Non-Volatile Data Storage Devices 152 may indicate that Type 1 Non-Volatile Data Storage Devices 152 each have a higher estimated lifetime (e.g. higher terabytes written before failure) than the estimated lifetime indicated in the performance characteristics for Type 2 Non-Volatile Data Storage Devices 156. Alternatively, the set of performance characteristics for Type 1 Non-Volatile Data Storage Devices 152 may indicate that Type 1 Non-Volatile Data Storage Devices 152 each have a lower estimated lifetime (e.g. lower terabytes written before failure) than the estimated lifetime indicated in the performance characteristics for Type 2 Non-Volatile Data Storage Devices 156. In either case, the performance characteristics of the non-volatile data storage device from which Physical Extent 1 170 is provisioned is different from the performance characteristics of the non-volatile storage device from which Physical Extent 2 172 is provisioned. Specifically, the estimated lifetime of the non-volatile data storage device from which Physical Extent 1 170 is provisioned may be higher or lower than the estimated lifetime of the non-volatile data storage device from which Physical Extent 2 172 is provisioned.

In some embodiments, Write Operations 174 may include or consist of multiple write operations that are received and performed by Mapping and Mirroring Logic 164, and Mapping and Mirroring Logic 164 may synchronously mirror the data indicated by each individual write operation. In such embodiments, Mapping and Mirroring Logic 164 only indicates the completion (e.g. returns a completion status or the like) for an individual write operation after the data indicated by that write operation has been successfully stored by Mapping and Mirroring Logic 164 into all of the physical extents in Mirror Set 168, e.g. into both Physical Extent 1 176 and Physical Extent 2 172. For example, Mapping and Mirroring Logic 164 may only indicate the completion of each individual write operation that it receives after Mapping and Mirroring Logic 164 receives both i) an indication from the non-volatile data storage device on which Physical Extent 1 170 is located that the data indicated by the write operation has been successfully stored in Physical Extent 1 170, and ii) an indication from the non-volatile data storage device on which Physical Extent 2 172 is located that the data indicated by the write operation has been successfully stored in Physical Extent 2 172. In this way, Mapping and Mirroring Logic 164 may be embodied to perform synchronous mirroring of Data 176 across physical extents provisioned from non-volatile data storage devices of disparate types.

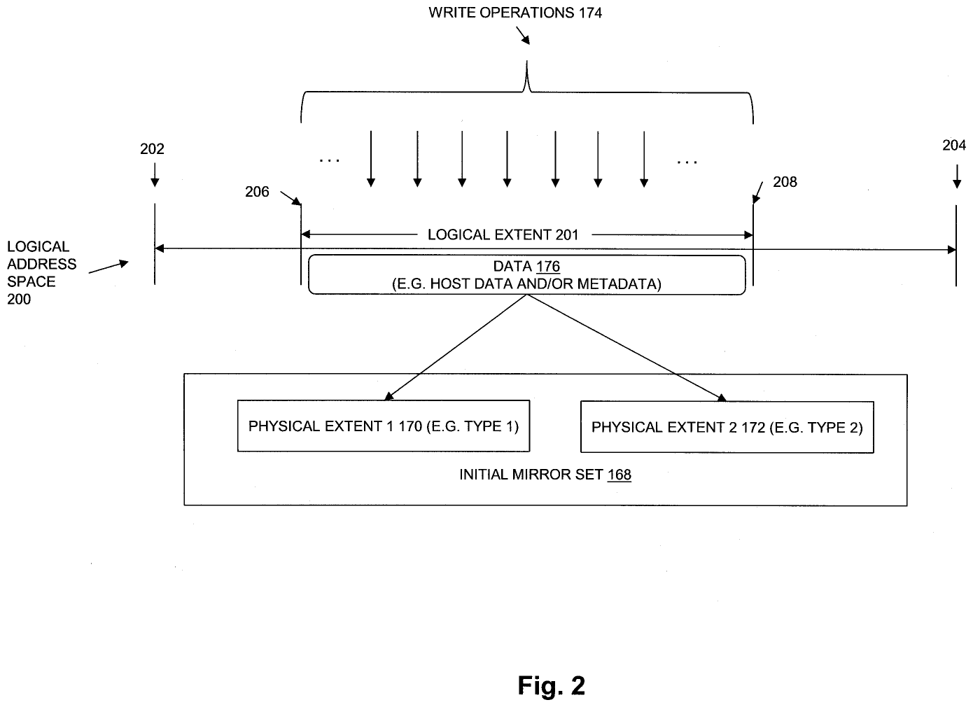

FIG. 2 is a block diagram showing how in some embodiments of the disclosed technology, Mapping and Mirroring Logic 164 may provide a Logical Address Space 200 in to which read and write operations may be directed by processes or threads within Host I/O Processing Logic 140. As shown in FIG. 2, Logical Address Space 200 may extend from a lowest possible logical address 202 through a highest possible logical address 204. Logical Address Space 200 may be divided into multiple separate and discrete logical extents, where each logical extent consists of a unique contiguous range of logical addresses within the Logical Address Space 200. Each logical extent within Logical Address Space 200 may be provisioned a corresponding mirror set of physical extents that is mapped to that logical extent, and onto which the data indicated by write operations directed to logical addresses that fall within that logical extent is synchronously mirrored by Mapping and Mirroring Logic 164. For example, as shown in FIG. 2, Logical Address Space 200 may include a Logical Extent 201 consisting of the set of contiguous logical addresses that extend from some relatively lower logical address 206 through some relatively higher logical address 208. As further shown in FIG. 2, Write Operations 174 may consist of a number of write operations that are each individually directed to one or more of the logical addresses that fall within the range of logical addresses in Logical Extent 201. As additionally shown in FIG. 2, Mirror Set 168 may correspond to and be mapped to Logical Extent 201 by Mapping and Mirroring Logic 164. As a result of Mirror Set 168 being mapped to Logical Extent 201, Mapping and Mirroring Logic 164 may synchronously mirror the Data 176 indicated by each one of the write operations in Write Operations 174 to each one of the physical extents in Mirror Set 168, e.g. to both Physical Extent 1 170 and Physical Extent 2 172.

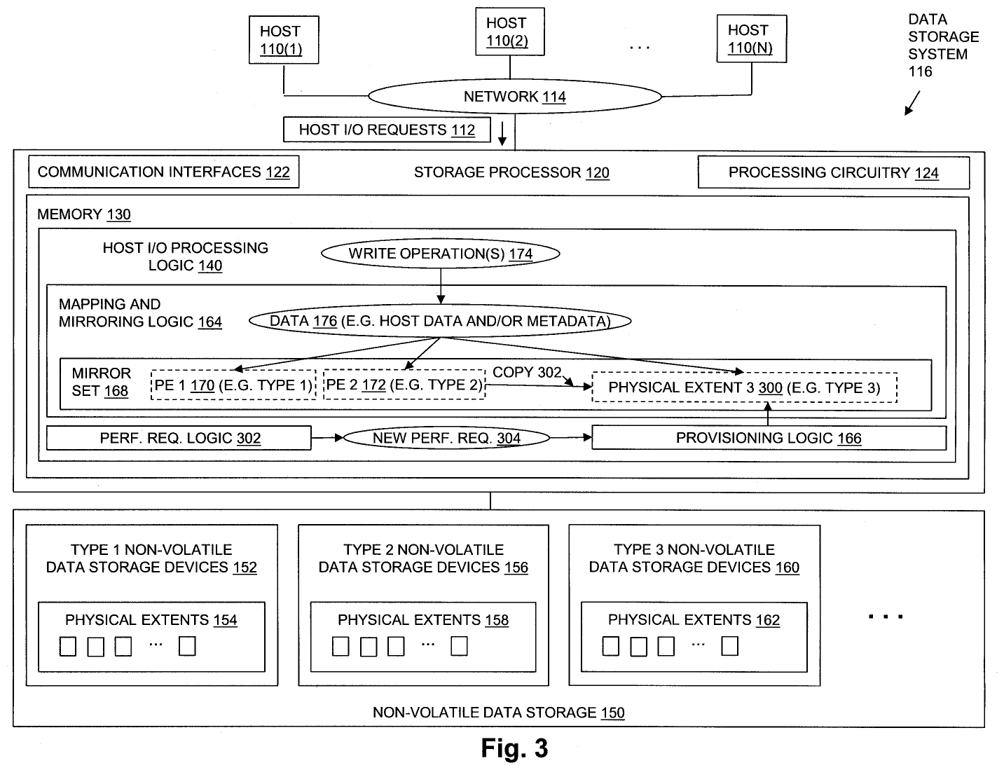

FIG. 3 shows the components of FIG. 1, and illustrates Performance Requirements Logic 302 detecting a change in the performance requirements for the Data 176 that is being mirrored. For example, Performance Requirements Logic 302 may monitor the access pattern of Data 176, e.g. the specific operations that are directed to the logical addresses within the Logical Extent 201 shown in FIG. 2. Such monitoring may capture a rate at which write operations directed to logical addresses within Logical Extent 201 are received, a rate at which read operations directed to logical addresses within Logical Extent 201 are received, and/or other specific rates and/or other workload patterns. Such rates may, for example, be maintained in what are sometimes referred to as “heat maps” that are associated with each logical extent, and that represent the workload activity for the associated logical extent. For example, a write operation heat map for a logical extent may represent the write operation workload directed to that logical extent as a temperature gradient from hot (representing high write activity) to cold (representing low write activity). Similarly, a read operation heat map for a logical extent may also represent the read operation workload directed to that logical extent as a temperature gradient from hot (representing high read activity) to cold (representing low read activity).

When the access pattern for Data 176 changes, Performance Requirements Logic 302 may i) generate new performance requirements for Data 176, shown by New Performance Requirements 304, and ii) pass New Performance Requirements 304 to Provisioning Logic 166. For example, in response to detecting a decrease in the rate at which write operations are being received that are directed to logical addresses within Logical Extent 201 (e.g. a change from hot to cold in terms of writes), Performance Requirements Logic 302 may generate New Performance Requirements 304 indicating that Data 176 now has a lower performance requirement with regard to the speed at which write operations are processed. Conversely, in response to detecting an increase in the rate at which write operations are being received that are directed to logical addresses within Logical Extent 201 (e.g. a change from cold to hot in terms of writes), Performance Requirements Logic 302 may generate New Performance Requirements 304 indicating that Data 176 now has a higher performance requirement with regard to the speed at which write operations are processed. Similarly, New Performance Requirements 304 may alternatively or in addition indicate a change in the rate at which read operations are being received, e.g. an increase or decrease. In another example, in response to Performance Requirements Logic 302 detecting that one of the physical extents in the mirror set is nearing its end of life, Performance Requirements Logic 302 may generate New Performance Requirements 304 indicating the physical extent that is nearing its end of life.

In some embodiments, New Performance Requirements 304 may alternatively, or in addition, indicate or consist of a change or changes made to the performance requirements for Data 176 by a system administrator or the like, e.g. indicating a change in a quality of service or the like that is required for Data 176.

For example, in the case where New Performance Requirements 304 indicate that the performance requirements of Data 176 have changed such that Data 176 now has a relatively lower performance requirement with regard to the speed at which write operations are processed (e.g. as may occur in the case of a write-once snapshot captured of a data storage object such as a logical unit or the like), Provisioning Logic 166 may operate in response to New Performance Requirements 304 by provisioning a physical extent from a non-volatile data storage device of another type that is different from the types of the non-volatile data storage devices from which Physical Extent 1 170 and Physical Extent 2 172 are provisioned, in that the newly provisioned physical extent has relatively lower performance in terms of write speed (e.g. higher access time). For example, in the case where Type 1 Non-Volatile Data Storage Devices 152 are high speed solid state drives (lowest access time), and Type 2 Non-Volatile Data Storage Devices 156 are relatively lower speed magnetic disk drives (second lowest access time), and Type 3 Non-Volatile Data Storage Devices 160 are external cloud storage servers (highest access time), Provisioning Logic 166 may provision Physical Extent 3 300 from one of the Type 3 Non-Volatile Data Storage Devices 160 to replace Physical Extent 2 172 in Mirror Set 168. Provisioning Logic 166 then copies the contents of Physical Extent 2 172 (i.e. the previously mirrored data that is currently stored on Physical Extent 2 172) from Physical Extent 2 172 to Physical Extent 3 300, as shown in FIG. 3 at reference number 302. During the time that the contents of Physical Extent 2 172 is being copied to the newly provisioned Physical Extent 3 300, Data 176 indicated by Write Operations 174 received during that time may be mirrored onto each of Physical Extent 1 170, Physical Extent 2 172, and Physical Extent 3 300.

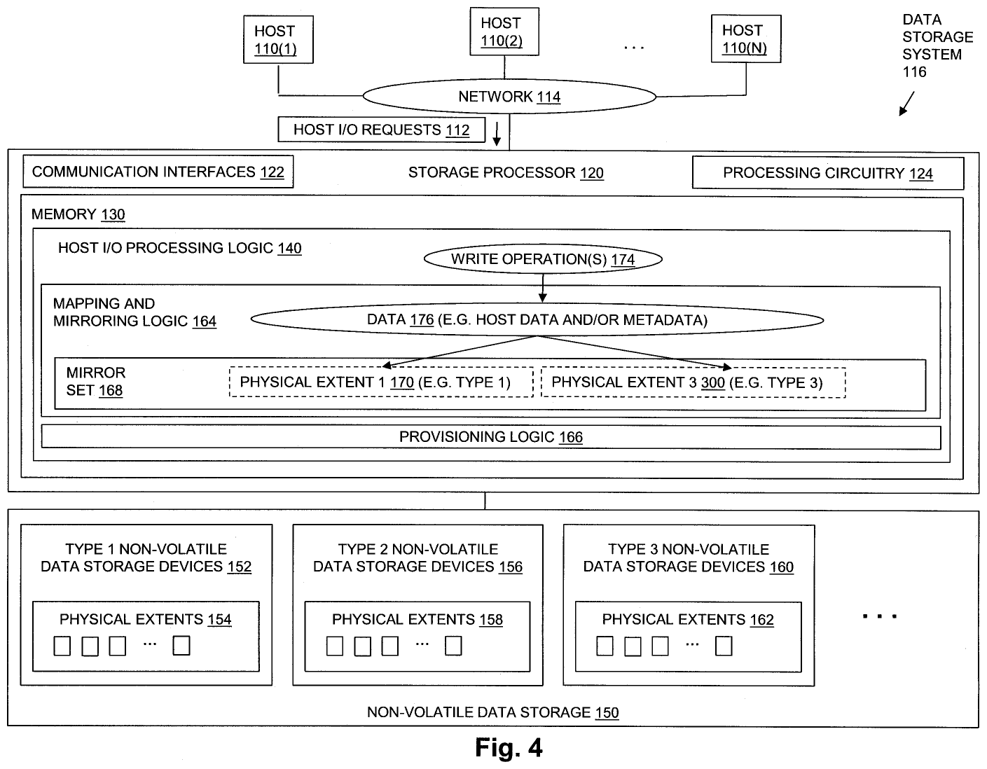

As shown in FIG. 4, following and/or in response to completion of the copying of the contents of Physical Extent 2 172 to Physical Extent 3 300, Mirror Set 168 is made up of Physical Extent 1 170 and Physical Extent 3 300, and Data 176 indicated by subsequently received write operations is mirrored onto Physical Extent 1 170 and Physical Extent 3 300. At that point in time, and further in response to completion of the copying of the contents of Physical Extent 2 172 to Physical Extent 3 300, Physical Extent 2 172 may be released from Mirror Set 168, and thereby made available for re-provisioning by Provisioning Logic 166 to another mirror set that can be used to mirror data indicated by write operations directed to a different logical extent within the logical address space, i.e. a logical extent other than Logical Extent 201.

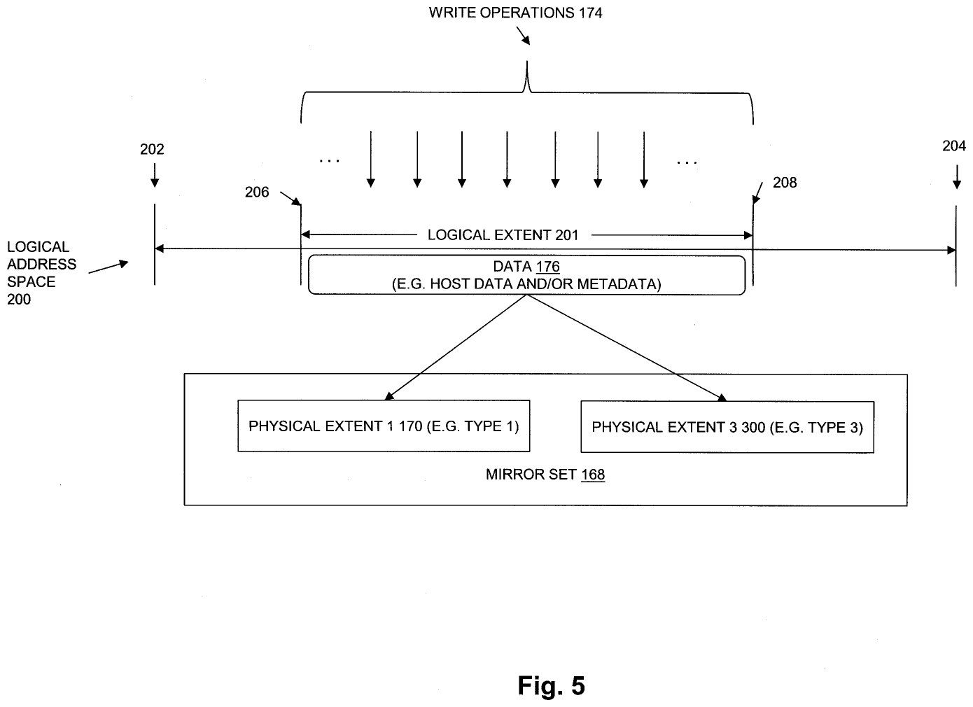

FIG. 5 shows how after the contents of Physical Extent 2 172 has been copied to Physical Extent 3 300, and Mirror Set 168 has been updated to contain Physical Extent 1 170 and Physical Extent 3 300, and Physical Extent 2 172 has been released for re-provisioning to support mirroring of data written to another logical extent, Data 176 indicated by subsequently received Write Operations 174 may be mirrored to Physical Extent 1 170 and Physical Extent 3 300.

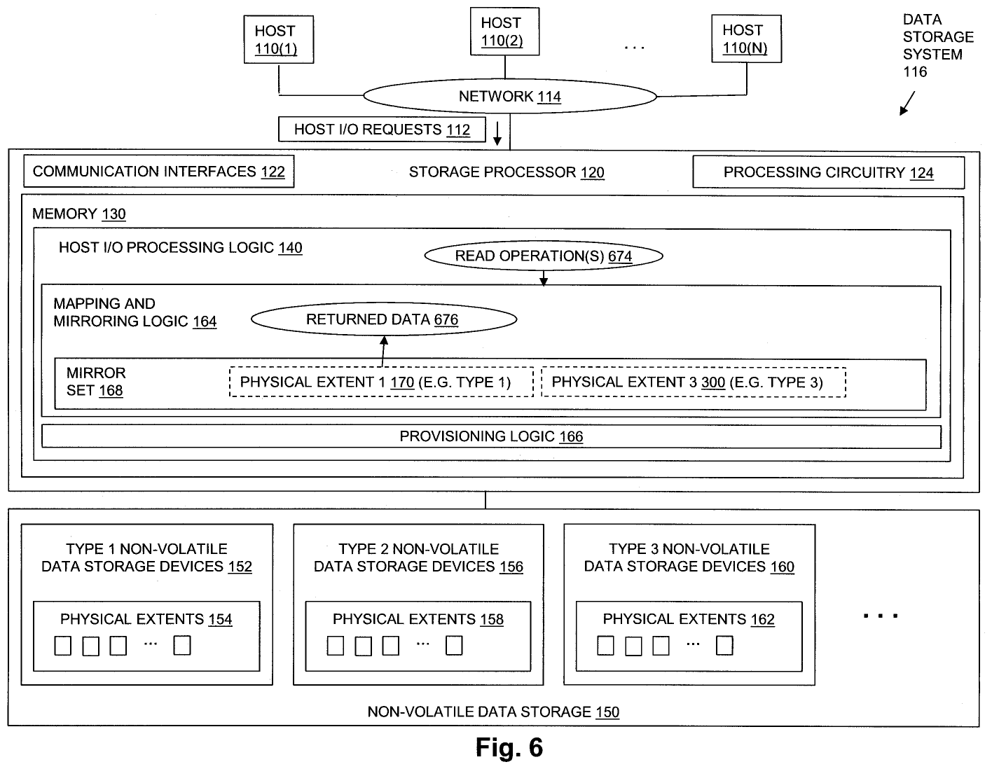

In some embodiments, as shown in FIG. 6, also after the contents of Physical Extent 2 172 has been copied to Physical Extent 3 300, and Mirror Set 168 has been updated to contain Physical Extent 1 170 and Physical Extent 3 300, and Physical Extent 2 172 has been released for re-provisioning to support mirroring of data written to another logical extent, subsequently received Read Operations 674 that are directed to logical addresses within the Logical Extent 201 may be processed (e.g. by Mapping and Mirroring Logic 164) using only the relatively higher speed Physical Extent 1 170, in order to provide the Returned Data 676 from the previously mirrored data stored on Physical Extent 1 170. In this way, for example in the case where the data written to Logical Extent 201 consists of a write once snapshot of a logical unit (LUN) or the like, and the contents of the snapshot is subsequently read as part of performing a recovery operation with regard to the LUN as the result of a failure or fault, the speed of the recovery operation reflects the access time of the relatively higher speed non-volatile data storage device on which Physical Extent 1 170 is located.

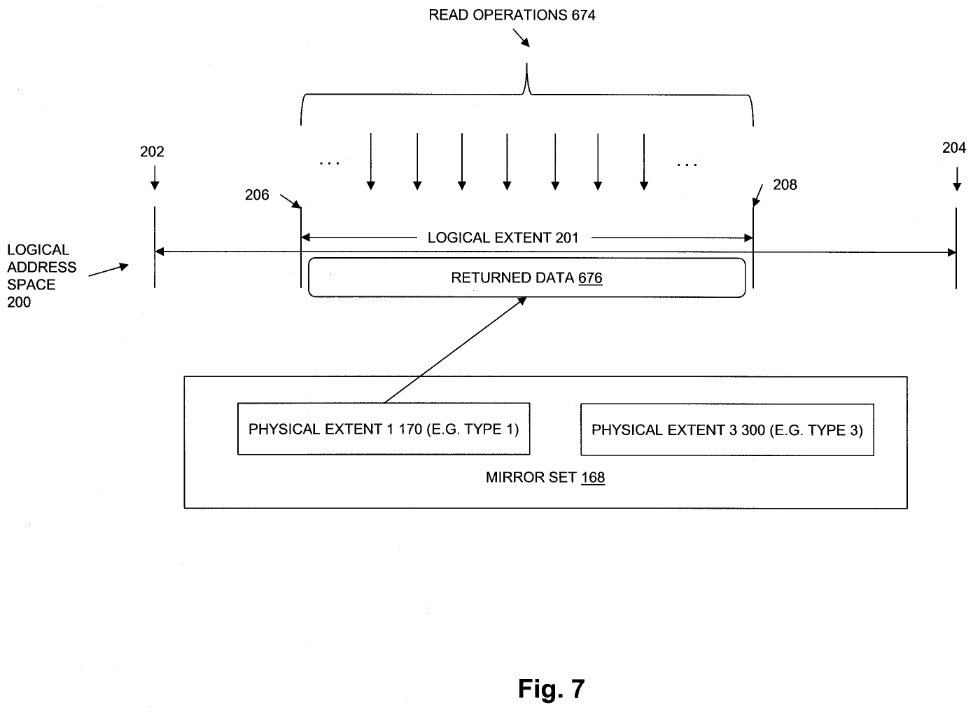

Similarly, FIG. 7 shows how the Read Operations 674 directed to logical addresses within the Logical Extent 201 may be processed (e.g. by Mapping and Mirroring Logic 164) to read the copy of the previously mirrored data from Physical Extent 1 170 in order to provide the Returned Data 676.

While the example above describes a case in which the New Performance Requirements 304 indicate that the Data 176 is to be down-tiered, resulting in down-tiering being performed by replacing one of the physical extents in Mirror Set 168 with a relatively lower performance, the disclosed technology is not limited to such cases. Those skilled in the art will recognize that various other specific operational cases are possible, such as, for example, New Performance Requirements 304 indicating that Data 176 is to be up-tiered, resulting in up-tiering being performed by replacing only one of the physical extents in Mirror Set 168 with a physical extent having relatively higher performance, and/or New Performance Requirements 304 indicating that one or both of the physical extents in Mirror Set 168 is reaching its end of life, resulting in one of the physical extents in Mirror Set 168 being replaced with a physical extent having relatively higher time remaining before its end of life.

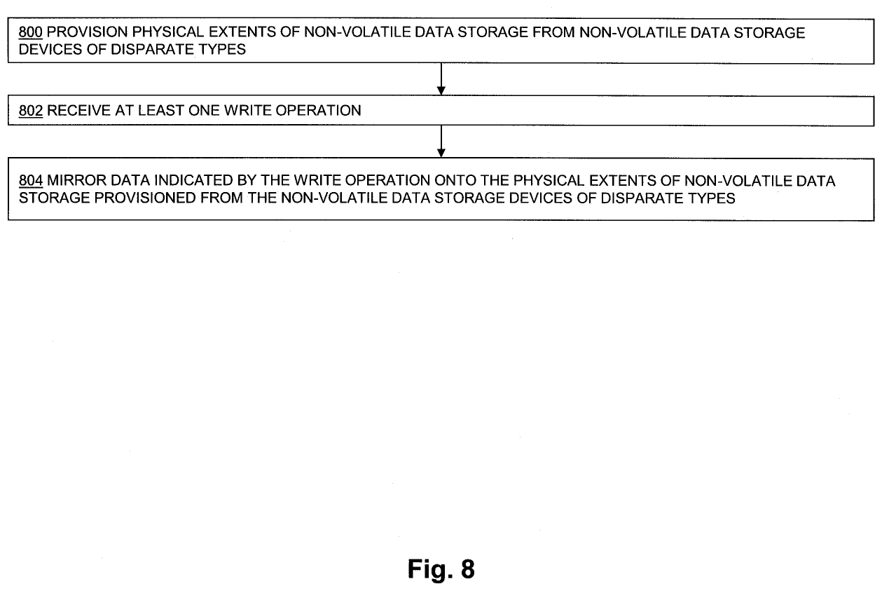

FIG. 8 is a first flow chart illustrating steps that may be performed during operation of some embodiments. As shown in FIG. 8, at step 800, physical extents of non-volatile data storage (e.g. a first physical extent and a second physical extent) are provisioned from non-volatile data storage devices of disparate types (e.g. from a non-volatile data storage device of a first type having a first set of performance characteristics and a non-volatile data storage device of a second type having a second set of performance characteristics that is different from the first set of performance characteristics).

At step 802, at least one write operation is received.

At step 804, data indicated by the write operation is mirrored onto the physical extents of non-volatile data storage provisioned from the non-volatile data storage devices of disparate types.

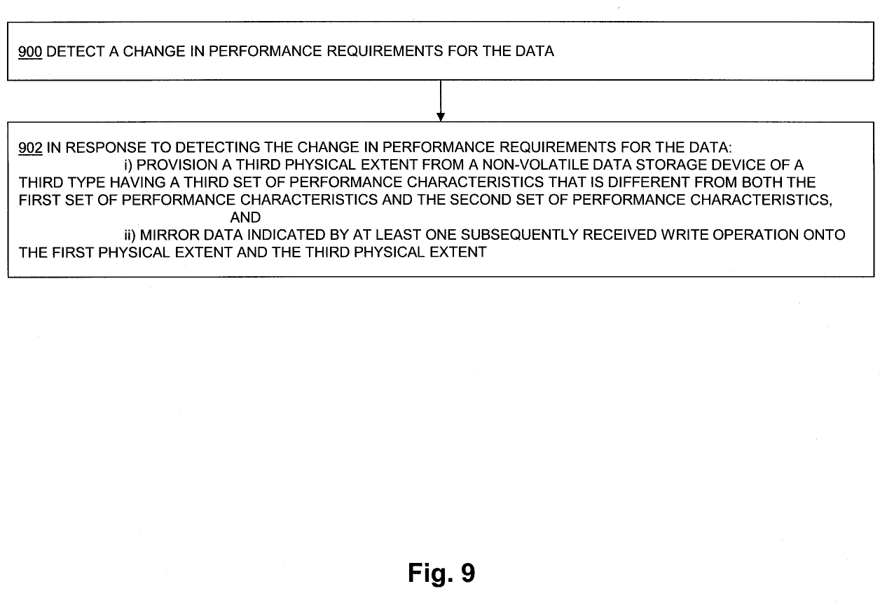

FIG. 9 is a second flow chart illustrating steps that may also be performed during operation of some embodiments. As shown in FIG. 9, at step 900 a change is detected in the performance requirements for the data.

At step 902, in response to detecting the change in the performance requirements for the data, i) a third physical extent is provisioned from a non-volatile data storage device of a third type having a third set of performance characteristics that is different from both the first set of performance characteristics and the second set of performance characteristics, and ii) data indicated by at least one subsequently received write operation is mirrored onto the first physical extent and the third physical extent.

As will be appreciated by those skilled in the art, the technologies disclosed herein may be embodied as a system, method or computer program product. Accordingly, each specific feature of the present disclosure may be embodied using hardware, software (including firmware, resident software, micro-code, etc.) or a combination of software and hardware. Furthermore, the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art will readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media.

While the invention is described through the above exemplary embodiments, it will be understood by those of ordinary skill in the art that modification to and variation of the illustrated embodiments may be made without departing from the inventive concepts herein disclosed.

1. A method comprising:
provisioning physical extents of non-volatile data storage from non-volatile data storage devices of disparate types, wherein the physical extents of non-volatile data storage comprise a first physical extent provisioned from a non-volatile data storage device having a first set of performance characteristics and a second physical extent provisioned from a non-volatile data storage device having a second set of performance characteristics;
receiving at least one write operation directed to at least one logical address within a logical extent of logical addresses;
mirroring data indicated by the write operation onto the first physical extent and the second physical extent;
detecting a change in performance requirements for data written to logical addresses within the logical extent at least in part by detecting a decrease in a rate at which write operations are being received that are directed to logical addresses within the logical extent of logical addresses; and
in response to detecting the change in performance requirements:
provisioning a third physical extent from a non-volatile data storage device having a third set of performance characteristics that is different from both the first set of performance characteristics and the second set of performance characteristics, and
mirroring data indicated by at least one subsequently received write operation onto the first physical extent and the third physical extent.

2. The method of claim 1, wherein the non-volatile data storage device having the first set of performance characteristics comprises a non-volatile data storage device of a first type; and
wherein the non-volatile data storage device having the second set of performance characteristics comprises a non-volatile data storage device of a second type.

3. The method of claim 2, wherein the first set of performance characteristics includes a speed of the non-volatile data storage device of the first type;
wherein the second set of performance characteristics includes a speed of the non-volatile data storage device of the second type; and
wherein the speed of the non-volatile data storage device of the second type is different from the speed of the non-volatile data storage device of the first type.

4. The method of claim 2, wherein the first set of performance characteristics includes reliability of the non-volatile data storage device of the first type;
wherein the second set of performance characteristics includes reliability of the non-volatile data storage device of the second type; and
wherein the reliability of the non-volatile data storage device of the second type is different from the reliability of the non-volatile data storage device of the first type.

5. The method of claim 2, wherein the first set of performance characteristics includes expected lifetime of the non-volatile data storage device of the first type;
wherein the second set of performance characteristics includes expected lifetime of the non-volatile data storage device of the second type; and
wherein the expected lifetime of the non-volatile data storage device of the second type is different from the expected lifetime of the non-volatile data storage device of the first type.

6. (canceled)

7. The method of claim 1, further comprising:
further in response to detecting the change in performance requirements for the data, copying contents of the second physical extent to the third physical extent; and
wherein mirroring of the data indicated by at least one subsequently received write operation onto the first physical extent and the third physical extent is performed in response to completion of the copying of the contents of the second physical extent to the third physical extent.

8. The method of claim 7, further comprising:
releasing the second physical extent for re-provisioning in response to completion of the copying of the contents of the second physical extent to the third physical extent; and
processing subsequently received read operations by reading the first physical extent.

9. The method of claim 1, wherein the at least one write operation comprises a plurality of write operations; and
indicating completion of each individual write operation in the plurality of write operations after the data indicated by that write operation is successfully mirrored onto each of the physical extents of non-volatile data storage provisioned from the non-volatile data storage devices of disparate types.

10. A data storage system, comprising:
processing circuitry and memory coupled to the processing circuitry, the memory storing instructions, wherein the instructions, when executed by the processing circuitry, cause the processing circuitry to:
provision physical extents of non-volatile data storage from non-volatile data storage devices of disparate types, wherein the physical extents of non-volatile data storage comprise a first physical extent provisioned from a non-volatile data storage device having a first set of performance characteristics and a second physical extent provisioned from a non-volatile data storage device having a second set of performance characteristics;
receive at least one write operation directed to at least one logical address within a logical extent of logical addresses;
mirror data indicated by the write operation onto the first physical extent and the second physical extent;
detect a change in performance requirements for data written to logical addresses within the logical extent at least in part by detecting a decrease in a rate at which write operations are being received that are directed to logical addresses within the logical extent of logical addresses; and
in response to detection of the change in performance requirements:
provision a third physical extent from a non-volatile data storage device having a third set of performance characteristics that is different from both the first set of performance characteristics and the second set of performance characteristics, and
mirror data indicated by at least one subsequently received write operation onto the first physical extent and the third physical extent.

11. The data storage system of claim 10, wherein the non-volatile data storage device having the first set of performance characteristics comprises a non-volatile data storage device of a first type; and
wherein the non-volatile data storage device having the second set of performance characteristics comprises a non-volatile data storage device of a second.

12. The data storage system of claim 11, wherein the first set of performance characteristics includes a speed of the non-volatile data storage device of the first type;
wherein the second set of performance characteristics includes a speed of the non-volatile data storage device of the second type; and
wherein the speed of the non-volatile data storage device of the second type is different from the speed of the non-volatile data storage device of the first type.

13. The data storage system of claim 11, wherein the first set of performance characteristics includes reliability of the non-volatile data storage device of the first type;
wherein the second set of performance characteristics includes reliability of the non-volatile data storage device of the second type; and
wherein the reliability of the non-volatile data storage device of the second type is different from the reliability of the non-volatile data storage device of the first type.

14. The data storage system of claim 11, wherein the first set of performance characteristics includes expected lifetime of the non-volatile data storage device of the first type;
wherein the second set of performance characteristics includes expected lifetime of the non-volatile data storage device of the second type; and
wherein the expected lifetime of the non-volatile data storage device of the second type is different from the expected lifetime of the non-volatile data storage device of the first type.

15. (canceled)

16. The data storage system of claim 10, wherein the instructions, when executed by the processing circuitry, further cause the processing circuitry to:
further in response to detection of the change in performance requirements for the data, copy contents of the second physical extent to the third physical extent; and
mirror the data indicated by at least one subsequently received write operation onto the first physical extent and the third physical extent in response to completion of the copying of the contents of the second physical extent to the third physical extent.

17. The data storage system of claim 16, wherein the instructions, when executed by the processing circuitry, further cause the processing circuitry to:
release the second physical extent for re-provisioning in response to completion of the copying of the contents of the second physical extent to the third physical extent; and
process subsequently received read operations by reading the first physical extent.

18. The data storage system of claim 10, wherein the at least one write operation comprises a plurality of write operations, and wherein the instructions, when executed by the processing circuitry, further cause the processing circuitry to:
indicate completion of each individual write operation in the plurality of write operations after the data indicated by that write operation is successfully mirrored onto each of the physical extents of non-volatile data storage provisioned from the non-volatile data storage devices of disparate types.

19. A computer program product, comprising:
a non-transitory, computer-readable medium having instructions stored thereon that, when executed by processing circuitry in a data storage system, cause the processing circuitry to perform a method comprising the steps of:
provisioning physical extents of non-volatile data storage from non-volatile data storage devices of disparate types, wherein the physical extents of non-volatile data storage comprise a first physical extent provisioned from a non-volatile data storage device having a first set of performance characteristics and a second physical extent provisioned from a non-volatile data storage device having a second set of performance characteristics;
receiving at least one write operation directed to at least one logical address within a logical extent of logical addresses;
mirroring data indicated by the write operation onto the first physical extent and the second physical extent;
detecting a change in performance requirements for data written to logical addresses within the logical extent at least in part by detecting a decrease in a rate at which write operations are being received that are directed to logical addresses within the logical extent of logical addresses; and
in response to detecting the change in performance requirements:
provisioning a third physical extent from a non-volatile data storage device having a third set of performance characteristics that is different from both the first set of performance characteristics and the second set of performance characteristics, and
mirroring data indicated by at least one subsequently received write operation onto the first physical extent and the third physical extent.

20. The method of claim 3, wherein the non-volatile data storage device having the third set of performance characteristics comprises a non-volatile data storage device of a third type;
wherein the third set of performance characteristics comprises a speed of the non-volatile data storage device of the third type; and
wherein the speed of the non-volatile data storage device of the third type is slower than the speed of the non-volatile data storage device of the first type and the speed of the non-volatile data storage device of the second type.
